(19) United States
(12) Patent Application Publication
(10) Pub. No.: US 2023/0164490 A1
(43) Pub. Date: May 25, 2023

(54) DIAPHRAGM AND SOUND GENERATING DEVICE USING THE DIAPHRAGM

(71) Applicant: GOERTEK INC., Shandong (CN)

(72) Inventors: Deyue WU, Shandong (CN); He LIANG, Shandong (CN); Minghui SHAO, Shandong (CN)

(73) Assignee: GOERTEK INC., Shandong (CN)

(21) Appl. No.: 17/997,218

(22) PCT Filed: Nov. 7, 2020
(86) PCT No.: PCT/CN2020/127369

§ 371 Date: Oct. 26, 2022

(30) Foreign Application Priority Data
Jun. 30, 2020 (CN) 202021238778.3

(51) Int. Cl. H04R 7/06; B32B 15/01; H04R 9/02; B32B 5/18; B32B 5/02

(52) U.S. Cl. CPC H04R 7/06; B32B 15/015; H04R 9/025; B32B 5/18; B32B 5/02

(57) ABSTRACT

The present disclosure provides a diaphragm and a sound generating device using the diaphragm. The diaphragm comprises a diaphragm body part, and a composite layer bonded to the center of the diaphragm body part. The composite layer comprises: a porous material layer; and a first metal layer and a second metal layer respectively disposed on two sides of the porous material layer. Compared with the prior art, the composite layer of the diaphragm adopts a composite structure composed of a porous material layer and metal layers, which can reduce the mass of the diaphragm and improve the modulus density ratio of the diaphragm while ensuring the rigidity of vibration. The porous structural material can increase the damping of the diaphragm, absorb the vibration energy under the specific resonant frequency, and thus effectively improve the high-frequency split vibration, reduce the distortion and improve the high pitched sound quality.

### CROSS-REFERENCE TO RELATED APPLICATION

This Application is a U.S. National-Stage entry under 35 U.S.C. § 371 based on International Application No. PCT/CN2020/127369, filed Nov. 7, 2020 which was published under PCT Article 21(2) and which claims priority to Chinese Application No. 202021238778.3, filed Jun. 30, 2020, which are all hereby incorporated herein in their entirety by reference.

### TECHNICAL FIELD

This application pertains to the technical field of sound generating devices, in particular to a diaphragm and a sound generating device using the diaphragm.

### BACKGROUND

With the continuous development of electronic equipment, the performance requirements for its components are becoming higher and higher, and other requirements for its components (such as being more lightweight) are also increasing. For audio equipment, this means that the diaphragm and other structures of the sound generating device must meet the requirement of large modulus density ratio. Moreover, in order to obtain good instantaneous response and sound quality, the diaphragm should also have an appropriate damping. In the traditional technology, the composite layer is mostly made of rigid materials, which increased the mass of the vibration part of the vibration system. Moreover, the damping effect of the composite layer structure in the traditional technology is poor. All the above factors ultimately affect the sound production performance of the diaphragm, which does not meet the high requirements of modern consumers for the performance of sound production devices.

Therefore, it is necessary to provide a new diaphragm and a sound generating device using the diaphragm to solve the above technical problems. In addition, other objects, desirable features and characteristics will become apparent from the subsequent summary and detailed description, and the appended claims, taken in conjunction with the accompanying drawings and this background.

### SUMMARY

The object of the present disclosure is to overcome the above technical problems, and provide a diaphragm with high modulus, low density and excellent performance and a sound generating device using the diaphragm.

In order to solve the first technical problem, the present disclosure adopts the following solutions.

A diaphragm, comprising: a diaphragm body part, and a composite layer bonded to a center of the diaphragm body part, wherein the composite layer comprises:

a porous material layer; and

a first metal layer and a second metal layer respectively disposed on two sides of the porous material layer.

Preferably, the porous material layer is a foam metal.

Preferably, the foam metal is at least one of foam aluminum, foam copper, foam nickel, foam iron or foam alloy.

Preferably, the first metal layer and the second metal layer are at least one of aluminum, copper or alloy materials.

Preferably, the first metal layer and the second metal layer are made of a same material or made of different materials.

Preferably, the first metal layer and the second metal layer are respectively bonded to two sides of the porous material layer by an adhesive or by a double sided adhesive tape.

Preferably, the first metal layer and the second metal layer have a thickness of 5-150 μm respectively, and a thickness ratio of them is 1:1-1:10.

Preferably, the porous material layer has a thickness of 0.05-1 mm.

Preferably, the composite layer is a flat plate structure.

Preferably, the composite layer is provided with uniformly spaced convex structures.

Preferably, the diaphragm body part comprises an inner edge, a bent ring and an outer edge in order from inside to outside, and the composite layer is bonded to the inner edge.

In order to solve the second technical problem, the present disclosure is realized as follows.

A sound generating device, comprising: a vibration system, and a magnetic circuit system, the vibration system comprising a diaphragm, wherein the diaphragm is the diaphragm according to any one of claims 1-10.

Compared with the prior art, the present disclosure has the following beneficial effects.

The composite layer of the diaphragm of the present disclosure adopts a composite structure composed of a porous material layer and metal layers, which can reduce the mass of the diaphragm and improve the modulus density ratio of the diaphragm while ensuring the rigidity of vibration. At the same time, the porous structural material can increase the damping of the diaphragm, absorb the vibration energy under the specific resonant frequency, and thus effectively improve the high-frequency split vibration, reduce the distortion and improve the high pitched sound quality.

The sound generating device of the present disclosure adopts the diaphragm, which has high reliability, significantly reduces the distortion of the sound generating device in the high-frequency stage, and improves the overall acoustic performance.

### BRIEF DESCRIPTION OF DRAWINGS

The present invention will hereinafter be described in conjunction with the following drawing figures, wherein like numerals denote like elements, and:

FIG. 1 is a schematic exploded view of the structure of a diaphragm in a sound generating device according to the present disclosure;

FIG. 2 is a partial enlarged view of FIG. 1 of the diaphragm in the sound generating device according to the present disclosure;

FIG. 3 is a schematic exploded view of the structure of the composite layer of a diaphragm in a sound generating device according to the present disclosure; and

FIG. 4 is a schematic exploded view of the structure of a diaphragm in a sound generating device according to another embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

Various exemplary embodiments of the present disclosure will now be described in detail with reference to the accompanying drawings. It should be noted that, unless otherwise specified, the components and the words describing the structural position such as “up” and “down” described in these embodiments are only for the placement mode of the components of the present disclosure and do not limit the scope of the present disclosure.

The following description of at least one exemplary embodiment is only illustrative in fact, and in no way serves as any restriction on the present disclosure and its application or use. In all the examples shown and discussed herein, any specific value should be interpreted as merely exemplary and not as a limitation. For those skilled in the art, the present disclosure can have various changes and variations. Any modification, equivalent replacement, improvement, etc. made within the spirit and principle of the present disclosure shall be included in the protection scope of the present disclosure.

### First Embodiment

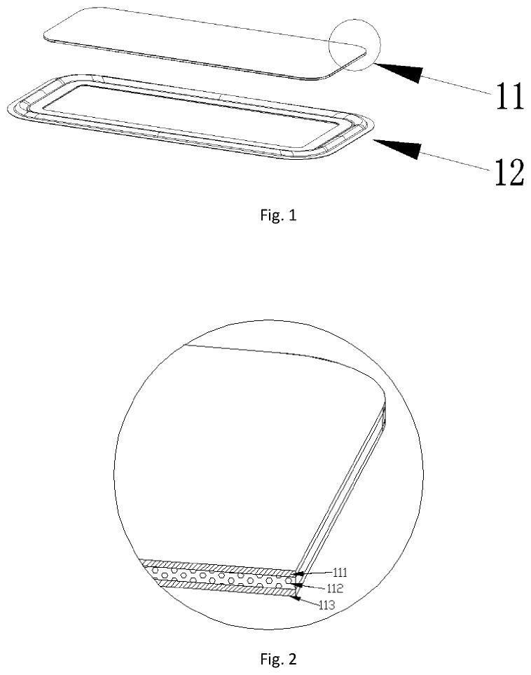

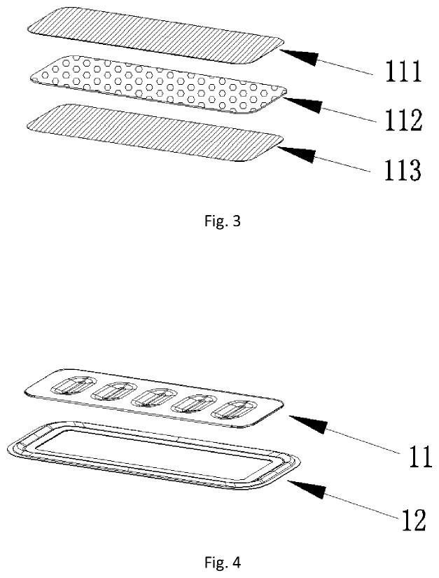

Referring to FIGS. 1 to 4, the diaphragm of the present disclosure comprises a diaphragm body part 12 and a composite layer 11 bonded to the center of the diaphragm body part 12. The composite layer 11 comprises a porous material layer 112, and a first metal layer 111 and a second metal layer 113 respectively disposed on two sides of the porous material layer 112.

Specifically, the porous material layer 112 is a foam metal layer. The foam metal layer may be made of foam aluminum, foam copper, foam nickel, foam iron or its foam alloy, and has a porous structure inside. The upper end face of the foam metal layer is provided with a first metal layer 111, and the lower end face of the foam metal layer is provided with a second metal layer 113. The first metal layer 111 and the second metal layer 113 are made of metal materials. The metal materials may be selected from, but are not limited to, aluminum, copper, nickel or other alloy materials, which belong to the common knowledge for those skilled in the art and will not be specifically described here.

The first metal layer 111 and the second metal layer 113 may be bonded to the upper and lower ends of the foam metal layer by adhesive bonding. For example, they may be bonded by means of adhesive coating or by a double sided adhesive tape.

In a specific embodiment of the present disclosure, the first metal layer 111 and the second metal layer 113 are made of different materials. For example, the first metal layer 111 is made of aluminum foil, and the second metal layer 113 is made of copper foil or alloy material.

In another specific embodiment of the present disclosure, the first metal layer 111 and the second metal layer 113 are made of the same material. For example, both the first metal layer 111 and the second metal layer 113 are made of aluminum foil.

The first metal layer 111 and the second metal layer 113 in the composite layer 11 of the diaphragm of the present disclosure have a thickness of 5-150 μm respectively, and a thickness ratio of them is 1:1-1:10. Preferably, the thickness of the first metal layer 111 is the same as that of the second metal layer 113, so that the first metal layer 111 and the second metal layer 113 are symmetrically arranged with respect to the porous material layer 112. The symmetrical arrangement structure of the composite layer 11 can reduce the polarization problem when the diaphragm vibrates. It should be noted that in practical applications, considering the requirements of product weight and heat dissipation, the first metal layer 111 and the second metal layer 113 may also be designed to have different thicknesses, which can be determined according to the product and actual needs.

Specifically, the thickness of the porous material layer 112 may be selected between 0.05 mm and 1 mm. It should be noted here that those skilled in the art can reasonably select the thicknesses of the first metal layer 111, the second metal layer 113 and the porous material layer 112 according to actual needs, which will not be specifically described here.

For the diaphragm of the present disclosure, the middle layer of the composite layer 11 is made of foam metal with porous structure, and the upper and lower sides are bonded with aluminum foil, aluminum foil, nickel or metal alloy, which reduces the mass of the whole composite layer 11 structure; moreover, the porous foam metal can provide greater internal damping for the composite layer 11 structure, so as to improve the sound generation performance of the diaphragm. At the same time, the foam metal material has high temperature and humidity resistance, which can improve the temperature resistance and service life of the sound generating device; moreover, its cost is low.

In a preferred embodiment of the present disclosure, the composite layer 11 structure is of a flat plate shape, as shown in FIG. 1. In another preferred embodiment of the present disclosure, a convex structure bent to one side is provided on the composite layer 11 structure, as shown in FIG. 4. There may be one convex structure which is provided in the middle of the composite layer 11 structure. Of course, there may also be a plurality of convex structures which are uniformly distributed on the composite layer 11 structure. The high frequency response of the diaphragm can be expanded by the convex structure, thereby improving the high frequency effect of the diaphragm.

The diaphragm of the present disclosure comprises a diaphragm body part 12 and the composite layer 11 structure as stated above. The diaphragm body part 12 comprises an inner edge, a bent ring and an outer edge in order from inside to outside. The composite layer 11 is fixed on the inner edge of the diaphragm body part 12 by an adhesive or by a double sided adhesive type, and the outer edge is fixed on the fixing system of the sound generating device.

The inner edge, bent ring and outer edge of the diaphragm of the present disclosure are integrally formed, and their materials may be one of engineering plastics (such as PEEK, par, etc.), elastomer materials (such as TPU, TPEE, silicone rubber, etc.), adhesive films (such as acrylic ester adhesive, silicone adhesive, etc.), etc., or a composite material of them. These materials are all diaphragm materials well known to those skilled in the art.

In the diaphragm of the present disclosure, the composite layer 11 bonded with the diaphragm body part 12 adopts a composite structure composed of a porous material layer 112 and metal layers, which can reduce the mass of the diaphragm and improve the modulus density ratio of the diaphragm while ensuring the rigidity. At the same time, the porous structural material can increase the damping of the diaphragm, absorb the vibration energy under the specific resonant frequency, and effectively improve the high-frequency split vibration.

### Second Embodiment

A sound generating device comprises a vibration system and a magnetic circuit system, the vibration system comprises a diaphragm, and the diaphragm is the diaphragm described in the first embodiment.

In the present disclosure, by using the diaphragm as stated above, the frequency response curve of the sound generating device in the high-frequency stage becomes smoother, the fluctuation of the curve is reduced, the distortion is reduced, and the high pitched sound quality is improved.

Although some specific embodiments of the present disclosure have been described in detail through examples, those skilled in the art should understand that the above examples are only for explanation, not to limit the scope of the present disclosure. Those skilled in the art should understand that the above embodiments can be modified without departing from the scope and spirit of the present disclosure. The scope of the present disclosure is defined by the claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A diaphragm, comprising: a diaphragm body part, and a composite layer bonded to a center of the diaphragm body part, wherein the composite layer comprises:
a porous material layer; and
a first metal layer and a second metal layer respectively disposed on two sides of the porous material layer.

2. The diaphragm according to claim 1, wherein the porous material layer is a foam metal.

3. The diaphragm according to claim 2, wherein the foam metal is at least one of foam aluminum, foam copper, foam nickel, foam iron or foam alloy.

4. The diaphragm according to claim 1, wherein the first metal layer and the second metal layer are at least one of aluminum, copper or alloy materials.

5. The diaphragm according to claim 1, wherein the first metal layer and the second metal layer are made of a same material or made of different materials.

6. The diaphragm according to claim 1, wherein the first metal layer and the second metal layer are respectively bonded to two sides of the porous material layer by an adhesive or by a double sided adhesive tape.

7. The diaphragm according to claim 1, wherein the first metal layer and the second metal layer have a thickness of 5-150 μm respectively, and a thickness ratio of them is 1:1-1:10.

8. The diaphragm according to claim 1, wherein the porous material layer has a thickness of 0.05-1 mm.

9. The diaphragm according to claim 1, wherein the composite layer is a flat plate structure.

10. The diaphragm according to claim 1, wherein the composite layer is provided with uniformly spaced convex structures.

11. The diaphragm according to claim 1, wherein the diaphragm body part comprises an inner edge, a bent ring and an outer edge in order from inside to outside, and the composite layer is bonded to the inner edge.

12. A sound generating device, comprising: a vibration system, and a magnetic circuit system, the vibration system comprises a diaphragm, wherein the diaphragm comprises: a diaphragm body part, and a composite layer bonded to a center of the diaphragm body part, the composite layer comprises:
a porous material layer; and
a first metal layer and a second metal layer respectively disposed on two sides of the porous material layer.

13. The diaphragm according to claim 12, wherein the porous material layer is a foam metal.

14. The diaphragm according to claim 13, wherein the foam metal is at least one of foam aluminum, foam copper, foam nickel, foam iron or foam alloy.

15. The diaphragm according to claim 12, wherein the first metal layer and the second metal layer are at least one of aluminum, copper or alloy materials.

16. The diaphragm according to claim 12, wherein the first metal layer and the second metal layer are made of a same material or made of different materials.

17. The diaphragm according to claim 12, wherein the first metal layer and the second metal layer are respectively bonded to two sides of the porous material layer by an adhesive or by a double sided adhesive tape.

18. The diaphragm according to claim 12, wherein the first metal layer and the second metal layer have a thickness of 5-150 μm respectively, and a thickness ratio of them is 1:1-1:10.

19. The diaphragm according to claim 12, wherein the porous material layer has a thickness of 0.05-1 mm.

20. The diaphragm according to claim 12, wherein the composite layer is a flat plate structure.
